(19) United States
(12) Patent Application Publication
(10) Pub. No.: US 2006/0176274 A1
(43) Pub. Date: Aug. 10, 2006

(54) Photographic type pointer positioning device

(76) Inventors: Chiu-Hao Cheng, Miaoli Hsien (TW); Ming-Gwo Cheng, Taichung Hsien (TW); Chun-Feng Tzu, Miaoli Hsien (TW)

Correspondence Address: BACON & THOMAS, PLLC, 625 SLATERS LANE, FOURTH FLOOR, ALEXANDRIA, VA, 22314, US

(21) Appl. No.: 10/546,764

(22) PCT Filed: Feb. 25, 2003
(86) PCT No.: PCT/US03/03127

§ 371 Date: Aug. 24, 2005

(51) Int. Cl. G09G 5/08

(52) U.S. Cl. 345/157

(57) ABSTRACT

A photographic type pointer positioning control device (200)for controlling the positioning of a pointer on a display (100)screen by means of photographing the display screen (100)with a video camera (230)and then processing the video signal thus obtained through an image out-line and recognition processing process and then computing the processed data through a computing unit into (240)a coordinate value corresponding to the aimed point of the video camera (230)at the display screen (100).

### BACKGROUND OF THE INVENTION

1. Field of the Invention

The present invention relates to a pointer positioning device adapted to control the positioning of a pointer on a display screen and, more particularly, to a photographic type pointer positioning device that can be used instead of a mouse or remote controller to control the positioning of the pointer on a display screen. The photographic type pointer positioning device uses a video camera to photograph the display zone of the display screen so as to obtain the actual coordinate value of the aimed point of the video camera at the display zone of the display screen through the processing of an image processing circuit and the computing of a computing unit.

2. Description of the Related Art

In recent years, various television sets of high-fidelity and high picture quality with surround sound effect have been developed to satisfy consumers' visual and audio quality requirements. According to conventional TV broadcasting methods, the television companies control the broadcasting time and contents no matter consumers like or not like. Following the coming of digital and network era, an advanced TV set is not simply an apparatus to receive audio and video signals provided by TV companies. A user can use an advanced TV set to selectively receive the desired information and to store or edit received information. A digital TV set provides the aforesaid functions and, can be connected to the Internet to receive any of a variety of interactive services. Further, a digital TV allows the user to edit the broadcasting of a TV program, to decide the broadcasting time and content. It is inevitable that the next generation of broadcasting technology involves digital TV.

Unlike the analog type of conventional TV sets, a digital TV set processes signal digitally. Conventional analog TV sets cannot receive digital TV signal directly. However, conventional analog TV sets can still be used to receive digital TV signal by means of a set-top box. There are three measures to receive digital TV signal as follows:
1. Install a set-top box in a conventional analog TV set to convert a cable signal to an input signal to the TV set. A set-top box can also be used to access the Word Wide Web.
2. Use a digital TV set to directly receive digital TV programs. Because a digital TV set has a built-in digital converter, it receives digital TV signal directly.
3. Install a DTV card in a personal computer. By means of a DTV card, a personal computer can receive digital TV signal.

However, a user needs to use a remote controller to select the channel and a mouse to click the menu when watching a digital TV set. This operation procedure is complicated and inconvenient.

### SUMMARY OF THE INVENTION

The present invention has been accomplished under the circumstances in view. It is therefore the main object of the present invention to provide a photographic type pointer positioning control device, which enables the user to select the channel and click the menu with one single control device when watching a digital TV set. It is another object of the present invention to provide a photographic type pointer positioning control device, which obtains the actual coordinate value of the pointer by means of the photographing of a video camera and the computing of a computing unit. According to the present invention, the photographic type pointer positioning control device is used with an information apparatus, for example, a digital TV, computer, or set-top box for analog TV, to produce a pointer coordinate value and to output the pointer coordinate value to the information apparatus for display on a display screen being connected to the information apparatus. The photographic type pointer positioning control device comprises a control circuit; a video camera controlled by the control circuit to photograph the display zone of the display screen and to send the photographed video signal back to the control circuit; an image processing circuit controlled by the control circuit to process the photographed video signal received by the control circuit from the video camera through an image out-line and recognition processing process and then to feed the processed data back to the control circuit; a computing unit controlled by the control unit to compute the actual coordinate value of the pointer on the display zone of the display screen and the actual coordinate value of the aimed point of the video camera at the display zone of the display screen subject to the processed data obtained from the image processing circuit through the control circuit, and then to send the computed coordinate values back to the control circuit; a set of buttons for enabling the user to input commands to control the aimed point of the video camera on the display zone of the display screen; an image synthesizing circuit linked to the display screen and controlled by the control circuit to synthesize the image of the actual coordinate value of the pointer and then to output the synthesized signal to the display screen for display on the display zone of the display screen; and a communication interface electrically connected to the control circuit for communication with the information apparatus.

### BRIEF DESCRIPTION OF THE DRAWINGS

FIG. 1 is a circuit block diagram of a photographic type pointer positioning control device according to the first embodiment of the present invention.

FIG. 2 is a flow chart explaining the operation of the first embodiment of the present invention.

FIG. 3 is a circuit block diagram of a photographic type pointer positioning control device according to the second embodiment of the present invention.

FIG. 4 is a flow chart explaining the operation of the second embodiment of the present invention.

### DETAILED DESCRIPTION OF THE PREFERRED EMBODIMENT

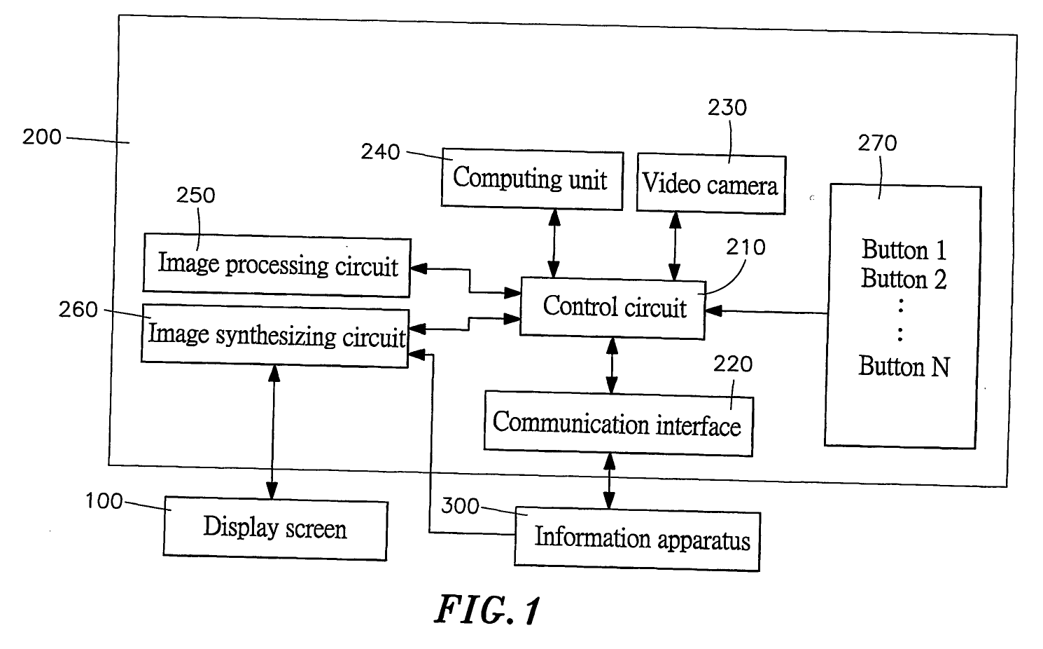

Referring to FIG. 1, a photographic type pointer positioning control device 200 according to the first embodiment of the present invention is connected to an information apparatus 300 through a communication interface 220. The photographic type pointer-positioning control device 200 comprises a control circuit 210, a video camera 230, a computing unit 240, an image processing unit 250, an image synthesizing circuit 260, and a set of buttons 270. The buttons 270 are electrically connected to the control circuit 210 for enabling the user to input commands to control the pointer on a display screen 100. The image synthesizing circuit 260 is electrically connected to the display screen 100, and adapted to map a particular mark, i.e., a pointer on the display screen 100 and then to transmit the coordinate data of the pointer to the information apparatus 300.

The video camera 230, the computing unit 240, the image processing circuit 250, and the image synthesizing circuit 260 are electrically connected to the control circuit 210. The control circuit 210 controls the video camera 230 to photograph the display zone of the display screen 100 and the pointer, and to transmit photographed video signal to the control circuit 210. Upon receipt of photographed video signal from the video camera 230, the control circuit 210 sends the signal to the image processing circuit 250 for image out-line and recognition processing. The processed data thus obtained is then sent back to the control circuit 210 by the image processing circuit 250, so that the control circuit 210 inputs the processed video signal into the computing unit 240, enabling the computing unit 240 to compute the actual value of the coordinates of the aiming point of the video camera 230 and the pointer on the display screen 100. The computing unit 240 outputs the computed coordinate values to the control circuit 210, and the control circuit 210 outputs the actual coordinate value of the pointer to the image synthesizing circuit 260, enabling the image synthesizing circuit 260 to synthesize the coordinate value of the pointer into the video signal being transmitted to the display screen 100 for display on the display zone of the display screen 100. At the same time the image synthesizing circuit 260 sends the coordinate value of the mark (pointer) to the information apparatus 300, enabling the information apparatus 300 to run the related mark (pointer) control operations.

The control circuit 210, image processing circuit 250 and computing unit 240 of the aforesaid photographic type pointer positioning control device 200 can be integrated into a single chip. Alternatively, the control circuit 210 and the computing unit 240 can be integrated into a single chip and then electrically connected to the image processing circuit 250. It is also practical to integrate the control circuit 210 and the image processing circuit 250 into a single chip and then electrically connected to the computing unit 240, or to make the control circuit 210 in the form of a single chip and then to connect this single chip to the image processing circuit 250 and the computing unit 240 electrically.

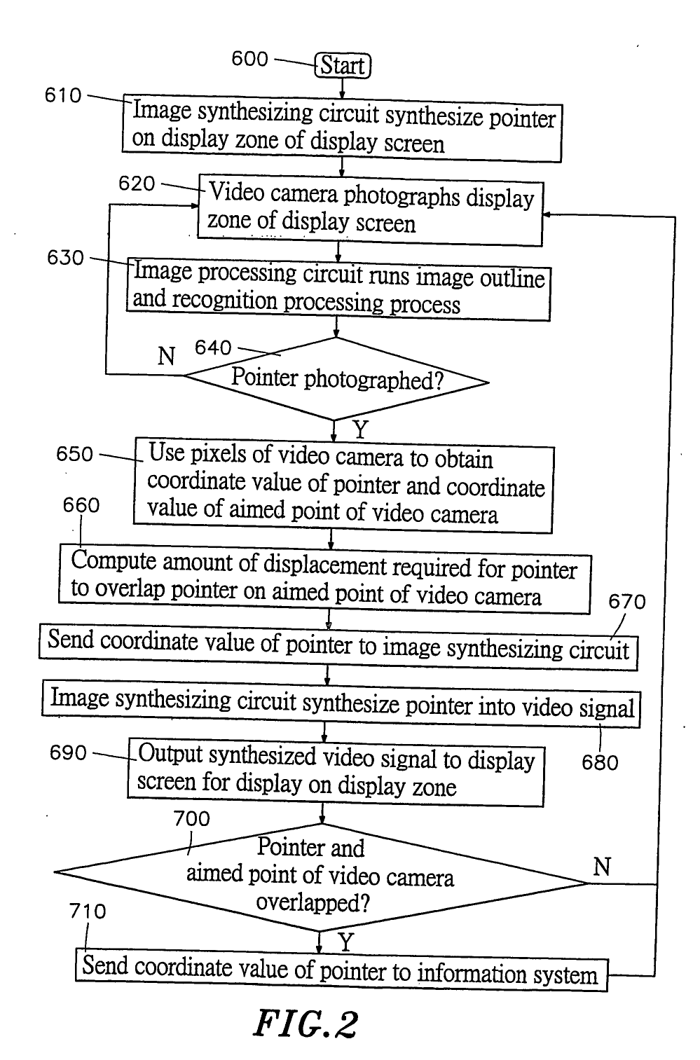

Referring to FIG. 2 and FIG. 1 again, when the user using the photographic type pointer positioning device 200 to control the mark (pointer) on the display screen 100, the control circuit 210 proceeds subject to the following coordinate value computing and judging procedure:
600 Start;
610 Drive the image synthesizing circuit 260 to synthesize the mark (pointer) onto the display zone of the display screen 100 subject to the command given by the user through the buttons 270;
620 Drive the video camera 230 to photograph the display zone of the display screen 100, and then drive the video camera 230 to transmit photographed video signal to the control circuit 210;
630 Transmit the video signal received from the video camera 230 to the image processing circuit 250 for image out-line and recognition processing, and then drive the image processing circuit 250 to transmit processed video signal to the control circuit 210;
640 Judge if the video camera 230 photographed the image of the mark (pointer) or not? Proceed to step (650) if positive, or return to step (620) if negative.
650 Compare the data obtained from the image processing circuit 250 with the pixels of the video camera 230 so as to obtain the coordinate value of the mark (pointer) on the display screen 100 and the image coordinate value of the aimed point of the video camera 230 at the display screen 100;
660 Send the coordinate value of the mark (pointer) on the display screen 100 and the coordinate value of the aimed point of the video camera 230 at the display screen 100 to the computing unit 240, and drive the computing unit 240 to put the coordinate values thus obtained into a distance formula respectively, so as to obtain the amount of displacement required for the mark (pointer) for enabling the mark (pointer) to be overlapped on the aimed point of the video camera 230 at the display screen 100;
670 Drive the computing unit 240 to compute the actual coordinate value of the mark (pointer) and to send the computed coordinate value back to the control circuit 210, enabling the control circuit 210 to transmit the actual coordinate value of the mark (pointer) to the image synthesizing circuit 260;
680 Drive the image synthesizing circuit 260 to synthesize the mark (pointer) into the video signal subject to the actual coordinate value obtained;
690 Drive the image processing circuit 260 to output the synthesized video signal to the display zone of the display screen 100 for display;
700 Check if the mark (pointer) and the aimed point of the video camera 230 are overlapped on the display zone of the display screen 100 or not? Proceed to step (710) if positive, or return to step (620) if negative; and
710 Send the coordinate value of the mark (pointer) to the information apparatus. 300, for enabling the information apparatus 300 to run the related mark (pointer) control operations.

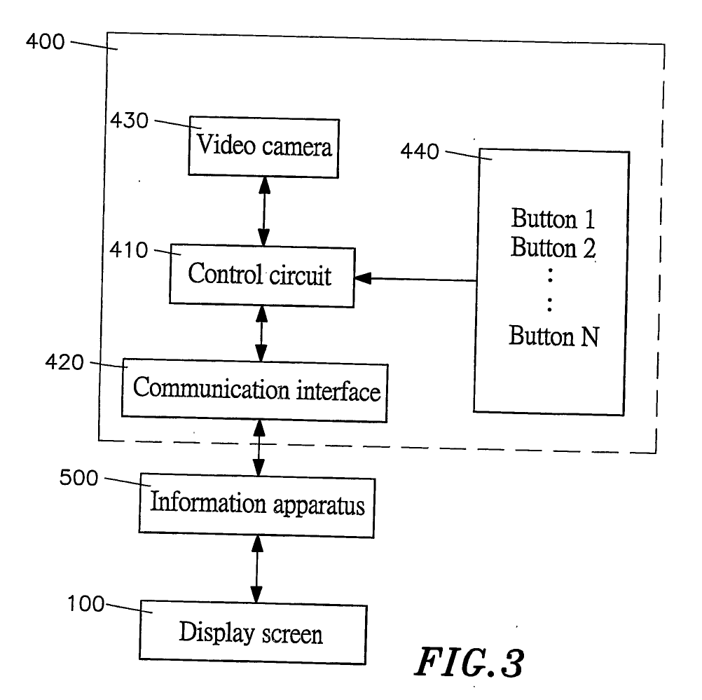

FIG. 3 shows a photographic type pointer positioning control device 400 according to the second embodiment of the present invention. This second embodiment is similar to the aforesaid first embodiment with the exception of the processing of the video signal from the video camera. According to the first embodiment of the present invention as shown in FIG. 2, the actual coordinate value of the aimed point of the video camera 230 at the display screen 100 and the actual coordinate value of the mark (pointer) on the display screen 100 are computed directly in the photographic type pointer positioning control device 200. According to the second embodiment of the present invention, the video signal is directly sent to the information apparatus 500 before processing, letting the information apparatus 500 to compute the actual coordinate value of the aimed point of the video camera 430 at the display screen 100.

Referring to FIG. 3 again, the photographic type pointer positioning control device 400 comprises a communication interface 420 connected to the information apparatus 500, a control circuit 410, a video camera 430, and a set of buttons 440. The control circuit 410 is respectively electrically connected to the video camera 430 and the buttons 440. The user can operate the buttons 440 to control the mark (pointer) on the display screen 100 of the information apparatus 500. The control circuit 410 can be formed of a single chip.

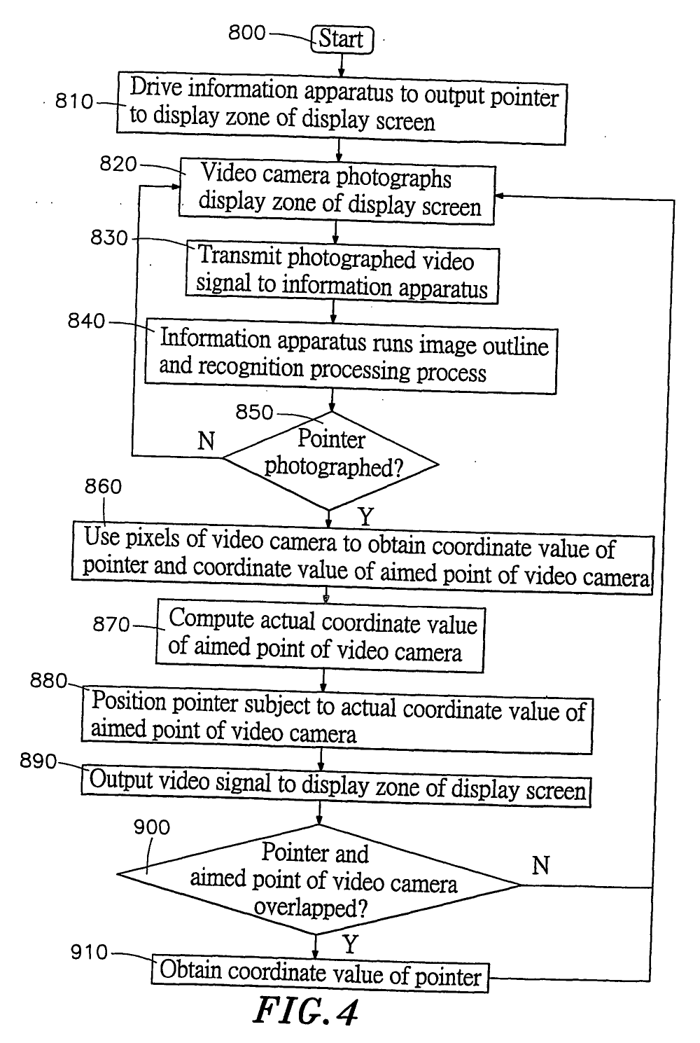

Referring to FIG. 4 and FIG. 3 again, when the user using the photographic type pointer positioning control device 400 and the information apparatus 500 to control the mark (pointer) on the display screen 100, the control circuit 410 and the information apparatus 500 run subject to the following coordinate value computing and recognition procedure:
800 Start;
810 Operate the buttons 440 to drive the information apparatus 500 to output the mark (pointer) to the display zone of the display screen 100;
820 Drive the video camera 430 to photograph the display zone of the display screen 100 and then to send the photographed video signal to the control circuit 410;
830 Drive the control circuit 410 to send the received video signal to the information apparatus 500 through the communication interface 420;
840 Drive the information apparatus 500 to processes the video signal received from the control circuit 410 through an image out-line and recognition processing procedure;
850 Judge if the video camera 430 has photographed the image of the mark (pointer) or not? And proceed to step (860) if positive, or return to step (820) if negative;
860 Drive the information apparatus 500 to compare the pixels of the video camera 430 so as to obtain the coordinate value of the aimed point of the video camera 430 at the display screen 100;
870 Drive the information apparatus 500 to compute the coordinate value of the aimed point of the video camera 430 at the display screen 100, and then to put the computed coordinate value into a distance formula so as to obtain the actual coordinate value of the aimed point of the video camera 430;
880 Drive the information apparatus 500 to position the mark (pointer) on the display zone of the display screen 100 subject to the actual coordinate value of the aimed point of the video camera 430 thus obtained;
890 Drive the information apparatus 500 to send the video signal to the display screen 100;
900 Check if the mark (pointer) and the aimed point of the video camera 430 are overlapped on the display zone of the display screen 100 or not? And proceed to step (910) if positive, or return to step (820) if negative; and
910 Obtain the coordinate value of the mark (pointer).

Referring to FIGS. 1 and 3 again, the information apparatus 300 or 500 can be a computer, digital TV, Set-Top Box (STB or IRD) for analog TV. The photographic type pointer positioning control device 200 or 400 can be used to replace a mouse, a tablet, or a light-gun.

The communication interface 220 or 420 of the photographic type pointer positioning control device 200 or 400 can be a USB (universal serial bus) interface, 1394 interface, PS2 interface, or any of a variety of suitable connecting interfaces connectable to the information apparatus 300 or 500 through a signal line for enabling the control circuit 210 or 410 to transmit signal through a wired communication method.

According to the present invention, the communication interface 220 or 420 is a wireless transmitting receiving interface having radio transmitter receiver circuit means. The information apparatus 300 or 500 has a corresponding radio transmitter receiver circuit means for signal transmission with the control circuit 210 or 410 wirelessly.

A prototype of photographic type pointer positioning control device has been constructed with the features of the annexed drawings of FIGS. 14. The photographic type pointer positioning control device functions smoothly to provide all of the features discussed earlier.

Although particular embodiments of the invention have been described in detail for purposes of illustration, various from the spirit and scope of the invention. Accordingly, the invention is not to be limited except as by the appended claims.

What the invention claimed is:

1. A photographic type pointer positioning control device used with an information apparatus to produce a pointer coordinate value and to output the pointer coordinate value to said information apparatus for display on a display screen being connected to said information apparatus, the photographic type pointer positioning control device comprising:
a control circuit;
a video camera controlled by said control circuit to photograph the display zone of said display screen and to send the photographed video signal back to said control circuit;
an image processing circuit controlled by said control circuit to process the photographed video signal received by said control circuit from said video camera through an image out-line and recognition processing process and then to feed the processed data back to said control circuit;
a computing unit controlled by said control unit to compute the actual coordinate value of the pointer on the display zone of said display screen and the actual coordinate value of the aimed point of said video camera at the display zone of said display screen subject to the processed data obtained from said image processing circuit through said control circuit, and then to send the computed coordinate values back to said control circuit;
a set of buttons for enabling the user to input commands to control the aimed point of the video camera on the display zone of said display screen;
an image synthesizing circuit linked to said display screen and controlled by said control circuit to synthesize the image of the actual coordinate value of the pointer and then to output the synthesized signal to said display screen for display on the display zone of said display screen; and
a communication interface electrically connected to said control circuit for communication with said information apparatus.

2. The photographic type pointer positioning control device as claimed in claim 1, wherein said control circuit, said image processing circuit and said computing unit are integrated into a single chip.

3. The photographic type pointer positioning control device as claimed in claim 1, wherein said control circuit and said computing unit are integrated into a single chip, which is electrically connected to said image processing circuit.

4. The photographic type pointer positioning control device as claimed in claim 1, wherein said control circuit and said image processing circuit are integrated into a single chip, which is electrically connected to said computing unit.

5. The photographic type pointer positioning control device as claimed in claim 1, wherein said control circuit is formed of a single chip, which is electrically connected to said image processing circuit and said computing unit.

6. A photographic type pointer positioning control device used with an information apparatus to produce a pointer coordinate value and to output the pointer coordinate value to said information apparatus for display on a display screen being connected to said information apparatus, the photographic type pointer positioning control device comprising:
a control circuit;
a video camera controlled by said control circuit to photograph the display zone of said display screen and to send the photographed video signal back to said control circuit;
a communication interface electrically connected to said control circuit and adapted to transmit video signal obtained by said video camera to said information apparatus;
a set of buttons for enabling the user to input commands to control the aimed point of the video camera on the display zone of said display screen;
wherein said control circuit drives said information apparatus to process the video signal obtained by said control circuit from said video camera through an image out-line and recognition processing process and to compute the processed data into a coordinate value corresponding to the aimed point of said video camera at the display zone of said display screen, and then drives said information apparatus to position the pointer on the display zone of said display screen subject to the actual coordinate value of the aimed point of said video camera thus obtained.

7. The photographic type pointer positioning control device as claimed in claim 6, wherein said control circuit is formed of a single chip.

8. The photographic type pointer positioning control device as claimed in claim 6, wherein said communication interface is connected to said information apparatus through a signal line for enabling said control circuit to transmit signal to said information apparatus through said signal line.

9. The photographic type pointer positioning control device as claimed in claim 6, wherein said communication interface is a wireless communication interface adapted to transmit signal to said information apparatus wirelessly.

10. The photographic type pointer positioning control device as claimed in claim 6, wherein said information apparatus is a set-top box.

11. The photographic type pointer positioning control device as claimed in claim 6, wherein said information apparatus is a computer.

12. The photographic type pointer positioning control device as claimed in claim 6, wherein said information apparatus is a digital TV.

13. The photographic type pointer positioning control device as claimed in claim 6, wherein said information apparatus is a TV game machine.
